(19) United States
(12) Patent Application Publication
(10) Pub. No.: US 2024/0396790 A1
(43) Pub. Date: Nov. 28, 2024

(54) COMMUNICATION CONTROL METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/795,773

(22) Filed: Aug. 6, 2024

Related U.S. Application Data
(63) Continuation of application No. PCT/JP2023/003783, filed on Feb. 6, 2023.

(30) Foreign Application Priority Data
Feb. 7, 2022 (JP) 2022-017333

(51) Int. Cl. H04L 41/0654; H04L 45/74

(52) U.S. Cl. CPC H04L 41/0654; H04L 45/74

(57) ABSTRACT

A communication control method is used in a cellular communication system. The communication control method includes: including, by a relay node, a packet; when the packet is a packet to be routed, rewriting, by the relay node, a first routing ID included in a header of the packet to a second routing ID, based on information used in header rewriting for routing; performing, by the relay node, routing processing of the packet for which the rewriting to the second routing ID has been performed; when the packet is a packet to be re-routed, rewriting, by the relay node, the first routing ID included in the header of the packet to a third routing ID, based on information used in header rewriting for re-routing; and performing, by the relay node, re-routing processing of the packet for which the rewriting to the third routing ID has been performed.

### RELATED APPLICATIONS

The present application is a continuation based on PCT Application No. PCT/JP2023/003783, filed on Feb. 6, 2023, which claims the benefit of Japanese Patent Application No. 2022-017333 filed on Feb. 7, 2022. The content of which is incorporated by reference herein in their entirety.

### TECHNICAL FIELD

The present disclosure relates to a communication control method used in a cellular communication system.

### BACKGROUND

The Third Generation Partnership Project (3GPP), which is a standardization project of a cellular communication system, has studied the introduction of a new relay node referred to as an Integrated Access and Backhaul (IAB) node (for example, see Non-Patent Document 1). One or more relay nodes are involved in communication between a base station and a user equipment and perform relay for the communication.

### CITATION LIST

### Non-Patent Literature

Non-Patent Document 1: 3GPP TS 38.300 V 16.8.0 (2021 December)

### SUMMARY

In a first aspect, a communication control method is used in a cellular communication system. The communication control method includes: including, by a relay node, a packet; when the packet is a packet to be routed, rewriting, by the relay node, a first routing ID included in a header of the packet to a second routing ID, based on information used in header rewriting for routing; performing, by the relay node, routing processing of the packet for which the rewriting to the second routing ID has been performed; when the packet is a packet to be re-routed, rewriting, by the relay node, the first routing ID included in the header of the packet to a third routing ID, based on information used in the header rewriting for re-routing; and performing, by the relay node, re-routing processing of the packet for which the rewriting to the third routing ID has been performed.

In a second aspect, a communication control method is used in a cellular communication system. The communication control method includes configuring, by a donor node, for a relay node, a priority configuration in which priorities are configured for respective paths of the relay node. The communication control method includes receiving, by the relay node, a packet. The communication control method includes selecting, by the relay node, a plurality of entries matching a first routing ID included in a header of the packet from a header rewriting table, and selecting a first entry of the plurality of entries corresponding to a path of the respective paths having a highest priority, based on the priority configuration. In addition, the communication control method includes rewriting, by the relay node, the first routing ID included in the header to a second routing ID included in the first entry.

In a third aspect, a relay node includes a transmitter including a packet, and a controller. The controller is configured to, when the packet is a packet to be routed, rewrite a first routing ID included in a header of the packet to a second routing ID, based on information used in header rewriting for routing, and perform routing processing of the packet for which the rewriting to the second routing ID has been performed. The controller is configured to, when the packet is a packet to be re-routed, rewrite the first routing ID included in the header of the packet to a third routing ID, based on information used in header rewriting for re-routing, and perform re-routing processing of the packet for which the rewriting to the third routing ID has been performed.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, parent nodes, and child nodes.

FIG. 3 is a diagram illustrating a configuration example of a gNB (base station) according to the embodiment.

FIG. 4 is a diagram illustrating a configuration example of an IAB node (relay node) according to the embodiment.

FIG. 5 is a diagram illustrating a configuration example of a UE (user equipment) according to the embodiment.

FIG. 6 is a diagram illustrating an example of a protocol stack related to an RRC connection and a NAS connection of an IAB-MT.

FIG. 7 is a diagram illustrating an example of a protocol stack related to an F1-U protocol.

FIG. 8 is a diagram illustrating an example of a protocol stack related to an F1-C protocol.

FIG. 9 is a diagram illustrating a configuration example of a cellular communication system according to a first embodiment.

FIG. 10 is a flowchart illustrating an operation example according to the first embodiment.

FIG. 11 is a diagram illustrating an example of multi-connectivity according to a second embodiment.

FIG. 12 is a diagram illustrating an example of multi-connectivity according to the second embodiment.

FIG. 13 is a diagram illustrating an operation example according to a second embodiment.

### DESCRIPTION OF EMBODIMENTS

An aspect has an object to provide a communication control method in which packet forwarding can be appropriately performed.

A cellular communication system in an embodiment is described with reference to the drawings. In the description of the drawings, the same or similar parts are denoted by the same or similar reference signs.

### Configuration of Cellular Communication System

A configuration example of the cellular communication system according to an embodiment is described. In an embodiment, a cellular communication system 1 is a 3GPP 5G system. Specifically, a radio access scheme in the cellular communication system 1 is New Radio (NR) being a 5G radio access scheme. Note that Long Term Evolution (LTE) may be at least partially applied to the cellular communication system 1. A future cellular communication system such as 6G may be applied to the cellular communication system 1.

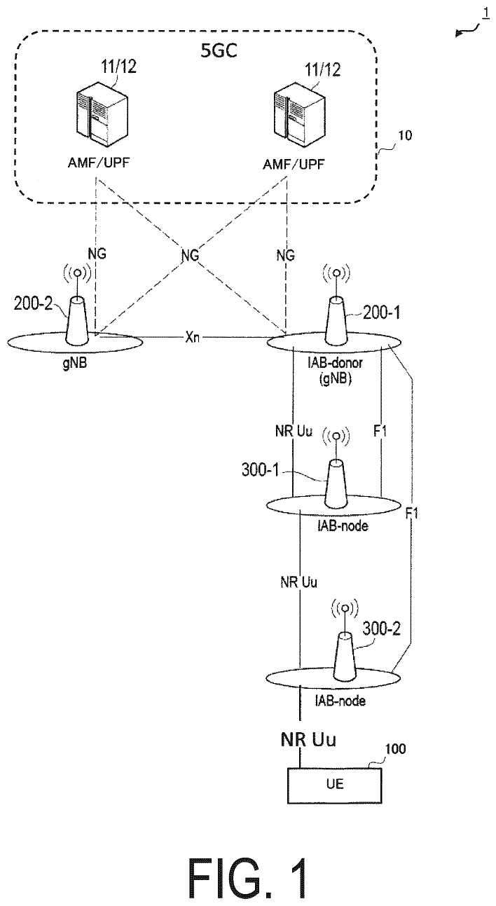

FIG. 1 is a diagram illustrating a configuration example of the cellular communication system 1 according to the embodiment.

As illustrated in FIG. 1, the cellular communication system 1 includes a 5G core network (5GC) 10, a User Equipment (UE) 100, base station apparatuses (hereinafter, also referred to as base stations in some cases) 200-1 and 200-2, and IAB nodes 300-1 and 300-2. The base station 200 may be referred to as a gNB.

An example in which the base station 200 is an NR base station is mainly described below, but the base station 200 may also be an LTE base station (i.e., an eNB).

Note that hereinafter, the base stations 200-1 and 200-2 may be referred to as a gNB 200 (or the base station 200 in some cases), and the IAB nodes 300-1 and 300-2 may be referred to as an IAB node 300.

The 5GC 10 includes an Access and Mobility Management Function (AMF) 11 and a User Plane Function (UPF) 12. The AMF 11 is an apparatus that performs various types of mobility controls and the like for the UE 100. The AMF 11 communicates with the UE 100 by using Non-Access Stratum (NAS) signaling, and thereby manages information of an area in which the UE 100 exists. The UPF 12 is an apparatus that performs transfer control of user data and the like.

Each gNB 200 is a fixed wireless communication node and manages one or more cells. The term “cell” is used to indicate a minimum unit of a wireless communication area. The term “cell” may be used to indicate a function or a resource for performing wireless communication with the UE 100. One cell belongs to one carrier frequency. Hereinafter, the cell and the base station may be used without distinction.

Each gNB 200 is interconnected to the 5GC 10 via an interface referred to as an NG interface. FIG. 1 illustrates a gNB 200-1 and a gNB 200-2 that are connected to the 5GC 10. Each gNB 200 may be divided into a Central Unit (CU) and a Distributed Unit (DU). The CU and the DU are interconnected via an interface referred to as an F1 interface. An F1 protocol is a communication protocol between the CU and the DU and includes an F1-C protocol that is a control plane protocol and an F1-U protocol that is a user plane protocol.

The cellular communication system 1 supports an IAB that uses NR for the backhaul to enable wireless relay of the NR access. The donor gNB 200-1 (or a donor node, which hereinafter may be also referred to as a “donor node”) is a donor base station that is a terminal node of the NR backhaul on the network side and includes additional functionality for supporting the IAB. The backhaul can implement multi-hop via a plurality of hops (i.e., a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted in two backhaul hops.

The UE 100 is a mobile wireless communication apparatus that performs wireless communication with the cells. The UE 100 may be any type of apparatus as long as the UE 100 is an apparatus that performs wireless communication with the gNB 200 or the IAB node 300. For example, the UE 100 includes a mobile phone terminal, a tablet terminal, a laptop PC, a sensor or an apparatus that is provided in a sensor, a vehicle or an apparatus that is provided in a vehicle, and an aircraft or an apparatus provided in an aircraft. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

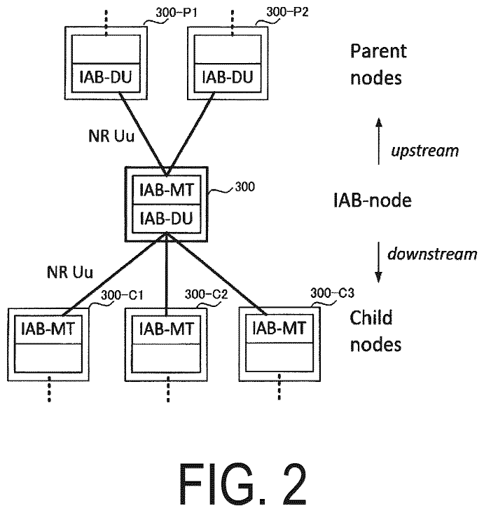

FIG. 2 is a diagram illustrating an example of a relationship between the IAB node 300, parent nodes, and child nodes.

As illustrated in FIG. 2, each IAB node 300 includes an IAB-DU corresponding to a base station functional unit and an IAB-Mobile Termination (IAB-MT) corresponding to a user equipment functional unit.

Neighboring nodes of the IAB-MT (i.e., upper node) of an NR Uu wireless interface are referred to as “parent nodes”. The parent node is the DU of a parent IAB node or the donor node 200. A radio link between the IAB-MT and each parent node is referred to as a backhaul link (BH link). FIG. 2 illustrates an example in which the parent nodes of the IAB node 300 are IAB nodes 300-P1 and 300-P2. Note that the direction toward the parent nodes is referred to as upstream. As viewed from the UE 100, the upper nodes of the UE 100 can correspond to the parent nodes.

Neighboring nodes of the IAB-DU (i.e., lower nodes) of an NR access interface are referred to as “child nodes”. The IAB-DU manages cells in a manner the same as, and/or similar to the gNB 200. The IAB-DU terminates the NR Uu wireless interface connected to the UE 100 and the lower IAB nodes. The IAB-DU supports the F1 protocol for the CU of the donor node 200-1. FIG. 2 illustrates an example in which the child nodes of the IAB node 300 are IAB nodes 300-C1 to 300-C3; however, the UE 100 may be included in the child nodes of the IAB node 300. Note that the direction toward the child nodes is referred to as downstream.

All of the IAB nodes 300 connected to the donor node 200 via one or more hops form a Directed Acyclic Graph (DAG) topology (which may be referred to as “topology” below) rooted at the donor node 200. In this topology, the neighboring nodes of the IAB-DU in the interface are child nodes, and the neighboring nodes of the IAB-MT in the interface are parent nodes as illustrated in FIG. 2. The donor node 200 performs, for example, centralized management on resources, topology, and routes of the IAB topology. The donor node 200 is a gNB that provides network access to the UE 100 via a network of backhaul links and access links.

### Configuration of Base Station

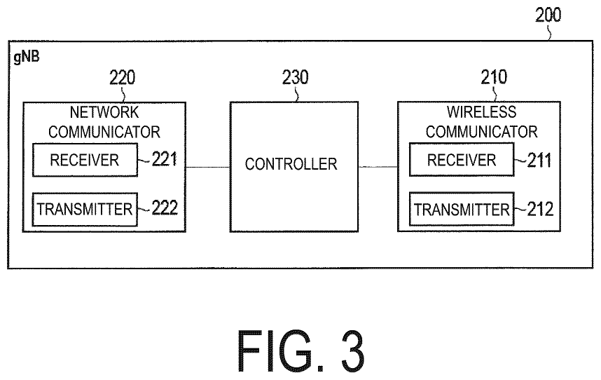

A configuration of the gNB 200 that is a base station according to the embodiment is described. FIG. 3 is a diagram illustrating a configuration example of the gNB 200. As illustrated in FIG. 3, the gNB 200 includes a wireless communicator 210, a network communicator 220, and a controller 230.

The wireless communicator 210 performs wireless communication with the UE 100 and performs wireless communication with the IAB node 300. The wireless communicator 210 includes a receiver 211 and a transmitter 212. The receiver 211 performs various types of reception under the control of the controller 230. The receiver 211 includes an antenna and converts (down-converts) a radio signal received by the antenna into a baseband signal (reception signal) which is then transmitted to the controller 230. The transmitter 212 performs various types of transmission under the control of the controller 230. The transmitter 212 includes an antenna and converts (up-converts) the baseband signal (transmission signal) output by the controller 230 into a radio signal which is then transmitted from the antenna.

The network communicator 220 performs wired communication (or wireless communication) with the 5GC 10 and performs wired communication (or wireless communication) with another neighboring gNB 200. The network communicator 220 includes a receiver 221 and a transmitter 222. The receiver 221 performs various types of reception under the control of the controller 230. The receiver 221 receives a signal from an external source and outputs the reception signal to the controller 230. The transmitter 222 performs various types of transmission under the control of the controller 230. The transmitter 222 transmits the transmission signal output by the controller 230 to an external destination.

The controller 230 performs various types of controls for the gNB 200. The controller 230 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. Note that the controller 230 may perform all of the processing and operations in the gNB 200 in each embodiment to be described below.

### Configuration of Relay Node

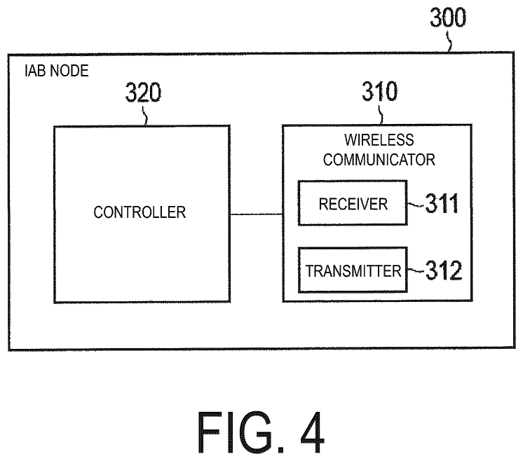

A configuration of the IAB node 300 that is a relay node (or a relay node apparatus. which may be also referred to as a “relay node” below) according to the embodiment will be described. FIG. 4 is a diagram illustrating a configuration example of the IAB node 300. As illustrated in FIG. 4, the IAB node 300 includes a wireless communicator 310 and a controller 320. The IAB node 300 may include a plurality of wireless communicators 310.

The wireless communicator 310 performs wireless communication with the gNB 200 (BH link) and wireless communication with the UE 100 (access link). The wireless communicator 310 for the BH link communication and the wireless communicator 310 for the access link communication may be provided separately.

The wireless communicator 310 includes a receiver 311 and a transmitter 312. The receiver 311 performs various types of reception under the control of the controller 320. The receiver 311 includes an antenna and converts (down-converts) a radio signal received by the antenna into a baseband signal (reception signal) which is then transmitted to the controller 320. The transmitter 312 performs various types of transmission under the control of the controller 320. The transmitter 312 includes an antenna and converts (up-converts) the baseband signal (transmission signal) output by the controller 320 into a radio signal which is then transmitted from the antenna.

The controller 320 performs various types of controls in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. Note that the controller 320 may perform all of the processing and operations in the IAB node 300 in each embodiment to be described below.

### Configuration of User Equipment

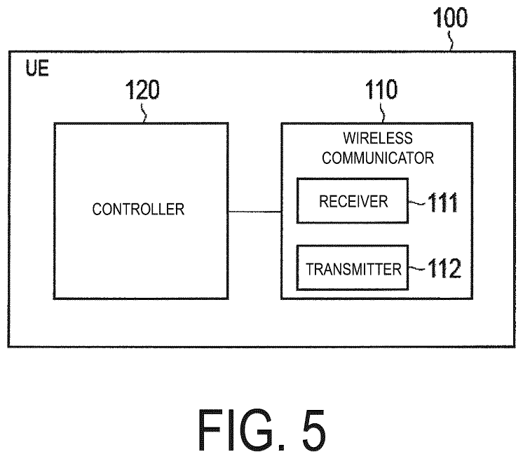

A configuration of the UE 100 that is a user equipment according to the embodiment is described next. FIG. 5 is a diagram illustrating a configuration example of the UE 100. As illustrated in FIG. 5, the UE 100 includes a wireless communicator 110 and a controller 120.

The wireless communicator 110 performs wireless communication in the access link, i.e., wireless communication with the gNB 200 and wireless communication with the IAB node 300. The wireless communicator 110 may also perform wireless communication in a sidelink, i.e., wireless communication with another UE 100. The wireless communicator 110 includes a receiver 111 and a transmitter 112. The receiver 111 performs various types of reception under the control of the controller 120. The receiver 111 includes an antenna and converts (down-converts) a radio signal received by the antenna into a baseband signal (reception signal) which is then transmitted to the controller 120. The transmitter 112 performs various types of transmission under the control of the controller 120. The transmitter 112 includes an antenna and converts (up-converts) the baseband signal (transmission signal) output by the controller 120 into a radio signal which is then transmitted from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. Note that the controller 120 may perform all of the processing in the UE 100 in each embodiment described below.

### Configuration of Protocol Stack

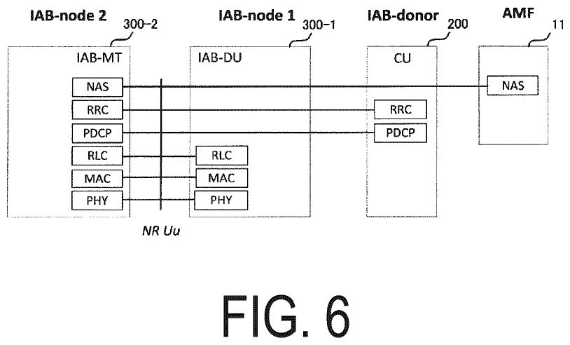

A configuration of a protocol stack according to the embodiment is described next. FIG. 6 is a diagram illustrating an example of a protocol stack related to an RRC connection and a NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through hybrid ARQ (HARQ: Hybrid Automatic Repeat reQuest), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines uplink and the downlink transport formats (transport block sizes, Modulation and Coding Schemes (MCSs)) and resource blocks.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression and decompression, and encryption and decryption. Data and control information are transmitted between the PDCP layer of the IAB-MT of the IAB node 300-2 and the PDCP layer of the donor node 200 via a radio bearer.

The RRC layer controls a logical channel, a transport channel, and a physical channel according to establishment, re-establishment, and release of a radio bearer. RRC signaling for various configurations is transmitted between the RRC layer of the IAB-MT of the IAB node 300-2 and the RRC layer of the donor node 200. When an RRC connection to the donor node 200 is present, the IAB-MT is in an RRC-connected state. When no RRC connection to the donor node 200 is present, the IAB-MT is in an RRC idle state.

The NAS layer which is positioned upper than the RRC layer performs session management, mobility management, and the like. NAS signaling is transmitted between the NAS layer of the IAB-MT of the IAB node 300-2 and the AMF 11.

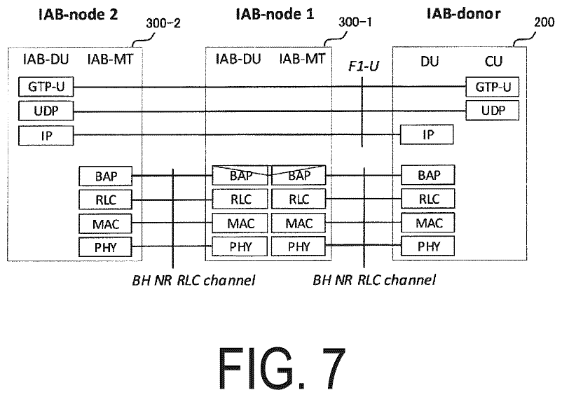

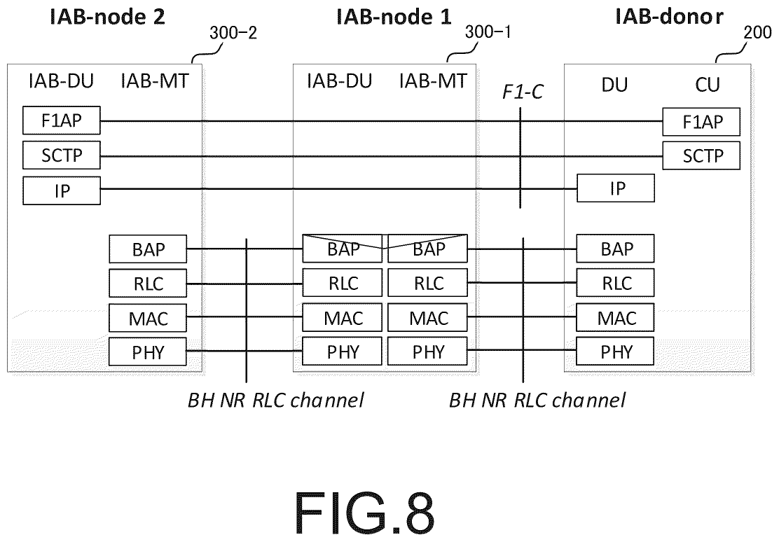

FIG. 7 is a diagram illustrating a protocol stack related to an F1-U protocol. FIG. 8 is a diagram illustrating a protocol stack related to an F1-C protocol. An example is illustrated in which the donor node 200 is divided into a CU and a DU.

As illustrated in FIG. 7, each of the IAB-MT of the IAB node 300-2, the IAB-DU of the IAB node 300-1, the IAB-MT of the IAB node 300-1, and the DU of the donor node 200 includes a Backhaul Adaptation Protocol (BAP) layer as an upper layer of the RLC layer. The BAP layer performs routing processing, and bearer mapping and demapping processing. In the backhaul, the IP layer is transmitted via the BAP layer to allow routing through a plurality of hops.

In each backhaul link, a Protocol Data Unit (PDU) of the BAP layer is transmitted by the backhaul RLC channel (BH NR RLC channel). Configuring each BH link to include a plurality of backhaul RLC channels enables the prioritization and QoS control of traffic. The association between the BAP PDU and the backhaul RLC channel is executed by the BAP layer of each IAB node 300 and the BAP layer of the donor node 200.

As illustrated in FIG. 8, the protocol stack of the F1-C protocol includes an FIAP layer and an SCTP layer instead of a GTP-U layer and a UDP layer illustrated in FIG. 7.

Note that in the description below, processing or operation performed by the IAB-DU and the IAB-MT of the IAB may be simply described as processing or operation of the “IAB”. For example, in the description, transmitting, by the IAB-DU of the IAB node 300-1, a message of the BAP layer to the IAB-MT of the IAB node 300-2 is assumed to correspond to transmitting, by the IAB node 300-1, the message to the IAB node 300-2. Processing or operation of the DU or CU of the donor node 200 may be described simply as processing or operation of the “donor node”.

An upstream direction and an uplink (UL) direction may be used without distinction. A downstream direction and a downlink (DL) direction may be used without distinction.

### First Embodiment

A first embodiment will be described.

### Routing and Re-Routing

Functions of the BAP layer include routing and re-routing.

The routing is, for example, to control which IAB node 300 the received packet is forwarded to. The BAP layer of the IAB node 300 performs routing, based on a BAP routing ID (which may be hereinafter referred to as a “routing ID”) included in the header of the received BAP packet (BAP PDU). Here, the routing ID includes a BAP address (Destination) (which may be hereinafter referred to as a “destination”) and a BAP path ID (Path ID) (which may be hereinafter referred to as a “path ID”). The BAP layer determines whether the destination in the routing ID included in the received BAP packet matches the BAP address of the subject station. When they match, the BAP layer determines that the destination has been reached. On the other hand, when the BAP address does not match the BAP address of the subject station, the BAP layer searches for an entry that matches the routing ID included in a routing table (or a routing configuration) (BH Routing Configuration). Then, the BAP layer transmits the received packet to the next hop address included in the entry. Note that the configuration of the routing table is performed by the CU of the donor node 200 transmitting an FIAP message including the routing table to the IAB-DU of the IAB node 300.

On the other hand, the re-routing refers to, for example, controlling the received packet to be forwarded to a destination node (an access IAB node or a donor node) via an alternative path. The re-routing is performed for a packet having no destination after the routing processing is performed. In other words, the re-routing is performed after the routing. The re-routing may be performed when the donor node explicitly configures an alternative path. The re-routing may be performed when the BAP layer appropriately selects a route that matches the destination of the received packet (a path having the same destination and a different path ID).

### Inter-CU Routing

The routing described above may be performed between the CUs of the donor nodes.

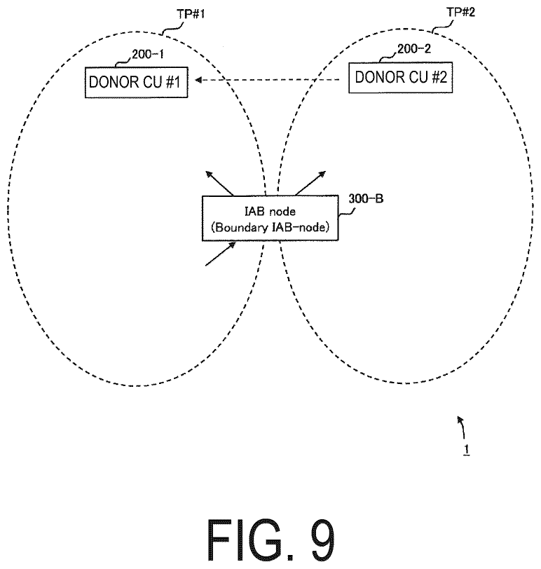

FIG. 9 is a diagram illustrating a configuration example of the cellular communication system 1 according to the first embodiment.

In FIG. 9, an example is illustrated in which a first topology (TP #1) is formed by the CU of the donor node 200-1 and a second topology (TP #2) is formed by the CU of the donor node 200-2. An example is illustrated in which an IAB node 300-B is deployed to bridge two topologies.

In such a case, the IAB node 300-B receives a packet transmitted from a child node on the first topology side. The destination of the packet is the CU of the donor node 200-2. In this case, the transmitter of the BAP layer (in the IAB-MT) of the IAB node 300-B can perform forwarding to the second topology through the routing processing. Specifically, the transmitter rewrites a routing ID (or a previous routing ID) included in the header of the packet to a new routing ID, using a header rewriting table (or a header rewriting configuration). Such processing may be referred to as header rewriting processing (BAP header rewiring operation). The packet with the rewritten header is forwarded to the CU of the donor node 200-2 as the destination.

Note that configuration of the header rewriting table is performed by the CU of the donor node 200-1 transmitting an FIAP message including the table to the IAB-DU of the IAB node 300-B, for example.

The example described above is an example of the inter-CU routing in the upstream direction. The inter-CU routing may be performed in the downstream direction as well.

For example, in the case of FIG. 9, the IAB node 300-B transmits the packet received from the parent node of the second topology (TP #2) to the child node of the first topology (TP #1). The destination of the packet is the access IAB node of the first topology (TP #1) (the node that first processes the packet received from the UE 100, or the node that last processes the packet to transmit to the UE 100). In this case as well, the transmitter of the BAP layer (in the IAB-DU) of the IAB node 300-B rewrites the routing ID included in the header of the received packet through the header rewriting processing. Thus, the packet after the header rewriting can be forwarded to the destination (the access IAB node of the first topology).

Note that, as with the IAB node 300-B illustrated in FIG. 9, the IAB node connected to a plurality of topologies may be referred to as a “boundary IAB node”. The inter-CU routing is performed in the boundary IAB node 300-B.

### Inter-CU Re-Routing

The re-routing described above may be performed between the CUs of the donor nodes 200.

In the case illustrated in FIG. 9, when the transmitter of the BAP layer (in the IAB-MT) of the boundary IAB node 300-B performs the routing processing described above but fails in the routing processing, the transmitter performs the header rewriting processing and performs the inter-CU re-routing. Specifically, when the transmitter of the BAP layer fails in the routing of the packet received from the child node, the transmitter rewrites the routing ID (or the previous routing ID) included in the header of the packet to a new routing ID, using the header rewriting table (Header Rewriting Configuration). The packet subjected to the header rewriting is forwarded to the CU of the donor node 200-2. Then, the CU of the donor node 200-2 forwards the received packet to the CU of the donor node 200-1. Thus, the packet is transmitted to the destination (the CU of the donor node 200-1).

Note that re-routing (inter-DU re-routing (inter-donor-DU re-routing)) may be performed between the DUs belonging to the same topology. For example, in the case of FIG. 9, a case is assumed in which two DUs (DU #1 of the donor node 200-1 and DU #2 of the donor node 200-1) are present under the CU of the donor node 200-1. In such a case, the IAB node 300 belonging to the same topology as the CU of the donor node 200-1 can forward the packet addressed to DU #1 of the donor node 200-1 to DU #2 of the donor node 200-1 through re-routing. In this case, the transmitter of the BAP layer (in the IAB-MT) of the IAB node 300 rewrites the previous routing ID included in the header of the packet to a new routing ID, using the header rewriting table (Header Rewriting Configuration). Through such header rewriting, the inter-DU re-routing can be performed.

In this manner, the header rewriting processing is also performed in the inter-CU re-routing, and the header rewriting processing is also performed in the inter-DU re-routing. Thus, the inter-CU re-routing and the inter-DU re-routing may be referred to as “header rewriting based re-routing” (header re-writing based re-routing).

### Problem in First Embodiment

As described above, the header rewriting processing is performed through the inter-CU routing. The header rewriting processing is also performed in the inter-CU re-routing. With the two types of header rewriting processing being performed in a common procedure to the extent possible, for example, it is expected that reliability, flexibility, and low delay of packet forwarding are enhanced. Thus, for example, in the IAB node 300, packet forwarding can be appropriately performed.

In view of this, the first embodiment has a problem to appropriately perform packet forwarding by causing the header rewriting processing in the routing and the header rewriting processing in the re-routing to be performed in a common procedure to the extent possible.

### Communication Control Method According to First Embodiment

Thus, in the first embodiment, the IAB node 300 first searches the header rewriting table both in the routing processing and in the re-routing processing, assuming to perform the re-routing processing after the routing processing. Then, when an entry that matches the header of the received packet is present in the header rewriting table, the IAB node 300 performs the header rewriting processing.

Specifically, firstly, the relay node (for example, the IAB node 300) receives a packet. Secondly, when a first routing ID included in the header of the packet to be routed is present in a first entry for the routing in the header rewriting table, the relay node rewrites the first routing ID to a second routing ID included in the first entry. Thirdly, when the first routing ID included in the header of the packet to be re-routed is present in a second entry for the re-routing in the header rewriting table, the relay node rewrites the first routing ID to a third routing ID included in the second entry.

In this manner, in the routing, the IAB node 300 first performs processing using the header rewriting table, and also in the subsequent re-routing, the IAB node 300 first performs processing using the header rewriting table. Thus, for example, the header rewriting processing in the routing and the header rewriting processing in the re-routing can be made common (or unified), and appropriate communication can be performed.

### Operation Example According to First Embodiment

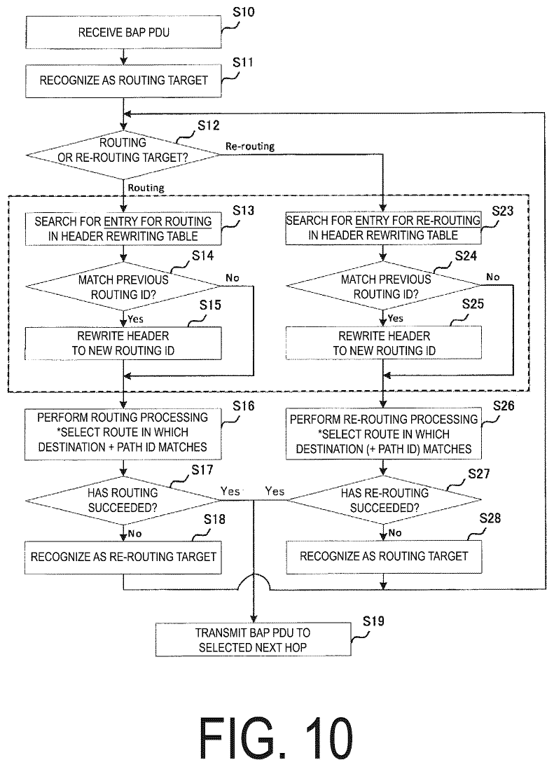

FIG. 10 is a diagram illustrating an operation example according to the first embodiment. For example, each processing illustrated in FIG. 10 is performed in the transmitter of the BAP layer in the IAB-MT of the boundary IAB node 300-B. In other words, it is packet forwarding in the upstream direction. The operation example illustrated in FIG. 10 will be described below by taking an example of packet forwarding in the upstream direction in the boundary IAB node 300-B.

As illustrated in FIG. 10, in Step S10, the transmitter of the BAP layer receives a packet (BAP PDU). The transmitter of the BAP layer may receive the packet (that is, the packet forwarded from another node) from a BAP receiver (of the IAB-DU). The transmitter of the BAP layer may receive the packet (that is, the packet received from the UE 100 under the IAB node 300) from an upper layer.

In Step S11, the transmitter of the BAP layer recognizes that the packet received in Step S10 is to be routed. The transmitter of the BAP layer may perform marking that the packet is a packet to be routed. The marking may be performed by storing in the memory in association with the packet.

In Step S12, the transmitter of the BAP layer determines whether the packet is to be routed or to be re-routed. When the packet is to be routed (“Routing” in Step S12), the processing proceeds to Step S13. On the other hand, when the packet is not to be routed (“Re-routing” in Step S12), the processing proceeds to Step S23. Alternatively, when the packet is to be re-routed (“Re-routing” in Step S12), the processing may proceed to Step S23, and when it is not to be re-routed (“Routing” in Step S12), the processing may proceed to Step S13. The transmitter of the BAP layer recognizes that the received packet is to be routed in Step S11, and thus the following description will be given based on the assumption that the processing of Step S13 is performed.

In Step S13, the transmitter of the BAP layer searches for an entry for the routing (that is, for the inter-CU routing) in the header rewriting table. The header rewriting table includes entries for the routing and entries for the re-routing. Thus, the header rewriting table in the routing processing and the header rewriting table in the re-routing processing can be made common.

In Step S14, the transmitter of the BAP layer determines whether an entry that matches the routing ID (or the previous routing ID) included in the header of the received packet is present in the entry (for example, the first entry) for the routing in the header rewriting table. When the entry that matches the previous routing ID is present in the entry for the routing in the header rewriting table (Yes in Step S14), the processing proceeds to Step S15. On the other hand, when the entry that matches the previous routing ID is not present in the entry for the routing in the header rewriting table (No in Step S14), the processing proceeds to Step S16.

In Step S15, the transmitter of the BAP layer rewrites the routing ID (previous routing ID) included in the header of the packet to a new routing ID included in the entry that matches the routing ID.

When the transmitter of the BAP layer performs the header rewriting in Step S15, in Step S16, the transmitter performs the routing processing through the inter-CU routing on the rewritten packet. In this case, the transmitter of the BAP layer attempts to transmit the packet in the route indicated by the routing ID after the header rewriting. On the other hand, in Step S16, the transmitter of the BAP layer performs the routing processing in the same topology on the packet not subjected to the header rewriting processing (Step S15). In this case, the transmitter of the BAP layer searches the routing table (BH Routing Configuration) for a routing ID that matches the routing ID included in the header of the packet, and attempts to transmit the packet in the route indicated by the routing ID. In other words, when the previous routing ID is not present in the entry for the routing in the header rewriting table, the transmitter of the BAP layer performs the routing processing, using the routing table.

In Step S17, the transmitter of the BAP layer determines whether the routing processing has succeeded. When the next hop BAP address is unavailable due to some reason, the transmitter of the BAP layer may determine that the routing processing has failed (No in Step S17). When an egress BH link is unavailable due to some reason, the transmitter of the BAP layer may determine that the routing processing has failed. In addition, when an egress BH RLC channel is unavailable due to some reason, the transmitter of the BAP layer may determine that the routing processing has failed. In addition, when the next hop BAP address is unavailable, the egress link is unavailable, and the egress BH RLC channel is unavailable, the transmitter of the BAP layer may determine that the routing processing has failed. Here, the reason is an RLF in the egress BH link, for example. On the other hand, when the transmitter of the BAP layer has successfully transmitted the packet to the next hop BAP address, using the egress BH RLC channel in the egress BH link corresponding to the next hop BAP address, the transmitter may determine that the routing has succeeded (Yes in Step S17). When the routing succeeds regarding the packet (Yes in Step S17), the processing proceeds to Step S19. On the other hand, when the routing fails regarding the packet (No in Step S17), the processing proceeds to Step S18.

In Step S18, the transmitter of the BAP layer recognizes that the packet is to be re-routed. The transmitter of the BAP layer may perform marking that the packet is a packet to be re-routed. The marking may be performed by storing in the memory in association with the packet. The processing proceeds to Step S12, and the processing described above is repeated.

On the other hand, in Step S19, in response to success in the routing, the packet is transmitted to the selected next hop.

Here, the following description will be given based on the assumption that the routing of the received packet fails (No in Step S17) and it is recognized that the packet is to be re-routed (Step S18).

In Step S23, the transmitter of the BAP layer searches for an entry for the re-routing in the header rewriting table. The header rewriting table itself is the same as and/or similar to that in the routing processing (Step S13).

In Step S24, the transmitter of the BAP layer determines whether an entry that matches the routing ID (or the previous routing ID) included in the header of the packet is present in the entry (for example, the second entry) for the re-routing in the header rewriting table. When the entry that matches the previous routing ID is present in the entry for the re-routing in the header rewriting table (Yes in Step S24), the processing proceeds to Step S25. On the other hand, when the entry that matches the previous routing ID is not present in the entry for the re-routing in the header rewriting table (No in Step S24), the processing proceeds to Step S26.

In Step S25, the transmitter of the BAP layer rewrites the routing ID (previous routing ID) included in the header of the packet to a new routing ID included in the entry that matches the routing ID.

When the transmitter of the BAP layer performs the header rewriting in Step S25, in Step S26, the transmitter performs the re-routing processing on the rewritten packet. In this case, for example, the transmitter of the BAP layer attempts to transmit the packet in the route that matches the destination included in the routing ID after the header rewriting. The BAP layer may attempt to transmit the packet in the route that matches the routing ID after the header rewriting. On the other hand, in Step S26, the transmitter of the BAP layer performs the re-routing processing (that is, local re-routing processing), in which the header rewriting is not performed, on the packet not subjected to the header rewriting processing (No in Step S24). In this case, the transmitter of the BAP layer selects a route that matches the destination of the routing ID included in the header of the packet, and attempts to transmit the packet in the route.

In Step S27, the transmitter of the BAP layer determines whether the re-routing processing has succeeded. When the next hop BAP address is unavailable due to some reason, the transmitter of the BAP layer may determine that the re-routing processing has failed (No in Step S27). When the egress BH link is unavailable due to some reason, the transmitter of the BAP layer may determine that the re-routing processing has failed. In addition, when the egress BH RLC channel is unavailable due to some reason, the transmitter of the BAP layer may determine that the re-routing processing has failed. In addition, when the next hop BAP address is unavailable, the egress link is unavailable, and the egress BH RLC channel is unavailable, the transmitter of the BAP layer may determine that the re-routing processing has failed. Here, the reason is an RLF in the egress BH link, for example. On the other hand, when the transmitter of the BAP layer has successfully transmitted the packet to the next hop BAP address, using the egress BH RLC channel in the egress BH link corresponding to the next hop BAP address, the transmitter may determine that the re-routing has succeeded (Yes in Step S27). When the re-routing succeeds regarding the packet (Yes in Step S27), the processing proceeds to Step S19. On the other hand, when the re-routing fails regarding the packet (No in Step S27), the processing proceeds to Step S28.

In Step S28, the transmitter of the BAP layer recognizes that the packet is to be routed. In other words, when the re-routing processing fails regarding the packet, the transmitter of the BAP layer considers that the packet is a packet to be routed. The transmitter of the BAP layer causes the packet to not be re-routed. Then, the processing proceeds to Step S12, and the processing described above is repeated. In other words, the transmitter of the BAP layer repeats the routing processing (the processing of Step S13 and subsequent steps) again regarding the packet.

The example described above has described an example using a method of recognizing whether the packet is to be routed or to be re-routed, but this is not restrictive. The transmitter of the BAP layer may recognize a packet, depending on whether the packet is to be routed. The transmitter of the BAP layer may recognize a packet, depending on whether the packet is to be re-routed. The packet not to be routed or the packet not to be re-routed may mean that no special recognition of the packet is present. For example, the packet recognized as a packet to be routed may be a target of the routing processing, and the packet not recognized as a packet to be routed may be a target of the re-routing processing. For example, the packet recognized as a packet to be re-routed may be a target of the re-routing processing, and the packet not recognized as a packet to be re-routed may be a target of the routing processing.

### Effect of First Embodiment

As illustrated in FIG. 10, the processing related to the header rewriting in the routing (Step S13 to Step S15) and the processing related to the header rewriting in the re-routing (Step S23 to Step S25) are the same, except for the entry to be referred to in the header rewriting table. Thus, the header rewriting processing in the routing processing and the header rewriting processing in the re-routing processing can be performed in a common procedure, and packet forwarding can be appropriately performed.

When the IAB node 300 performs the header rewriting processing and fails in the re-routing processing (No in Step S27), the IAB node 300 causes the packet to not be re-routed and considers the packet to be routed (Step S28). This allows the IAB node 300 to consider the packet to be routed, perform the header rewriting, and perform the routing processing again. Thus, the IAB node 300 can appropriately forward the packet.

### Second Embodiment

A second embodiment will be described.

Dual connectivity (DC) (which may be hereinafter referred to as “DC”) can also be applied between the IAB nodes 300. DC is a communication method using resources provided from two different nodes connected in a non-ideal backhaul link, for example. In this case, one is a master cell group (which may be hereinafter referred to as an “MCG”), and the other is a secondary cell group (which may be hereinafter referred to as an “SCG”). The MCG is a cell group of serving cells associated with a master node. On the other hand, the SCG is a group of serving cells associated with a secondary node. The IAB-MT of the IAB node 300 can connect to the master node that manages the MCG (for example, parent node #1 of the IAB node 300), and connect to the secondary node that manages the SCG (for example, parent node #2 of the IAB node 300).

For example, a case is assumed in which DC is configured in the boundary IAB node 300-B. In other words, a case is assumed in which the MCG is configured for parent node #1 on the first topology side and the SCG is configured for parent node #2 on the second topology side in the boundary IAB node 300-B. For example, when an RLF occurs in the BH link for parent node #1 on the first topology side, in the boundary IAB node 300-B, packet forwarding to parent node #2 on the second topology side is performed through the re-routing processing.

Here, a case is assumed in which multi-connectivity is introduced. While DC is a communication method in which connection is implemented with two links, multi-connectivity is a communication method in which connection is implemented with three or more links.

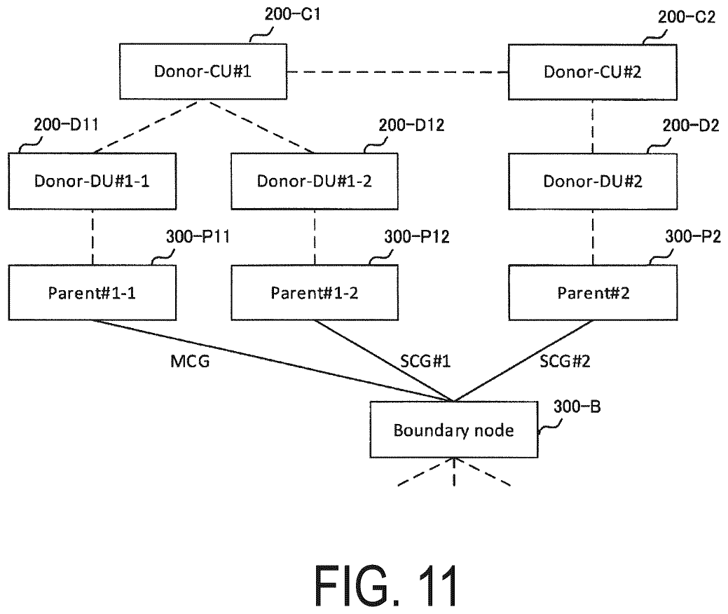

FIG. 11 is a diagram illustrating an example of multi-connectivity according to the second embodiment. In the example of FIG. 11, in the boundary IAB node 300-B, the MCG is configured for a parent node 300-P11 on the first topology side, SCG #1 is configured for a parent node 300-P12 on the first topology side, and SCG #2 is configured for a parent node 300-P2 on the second topology side.

Here, it is assumed that a BH RLF occurs in the link of SCG #1 of the first topology. In this case, there may be a problem whether the boundary IAB node 300-B is to perform the re-routing processing for the parent node 300-P11 of the first topology configured with MCG #1 or to perform the re-routing processing for the parent node 300-P2 of the second topology configured with SCG #2.

Particularly, as illustrated in FIG. 11, when the boundary IAB node 300-B selects the parent node 300-P11, the boundary IAB node 300-B performs the header rewriting processing through the inter-DU re-routing. Even when the boundary IAB node 300-B selects the parent node 300-P2, the boundary IAB node 300-B performs the header rewriting processing through the inter-CU re-routing. Regardless of which parent node 300-P the boundary IAB node 300-B selects, the boundary IAB node 300-B performs the header rewriting processing.

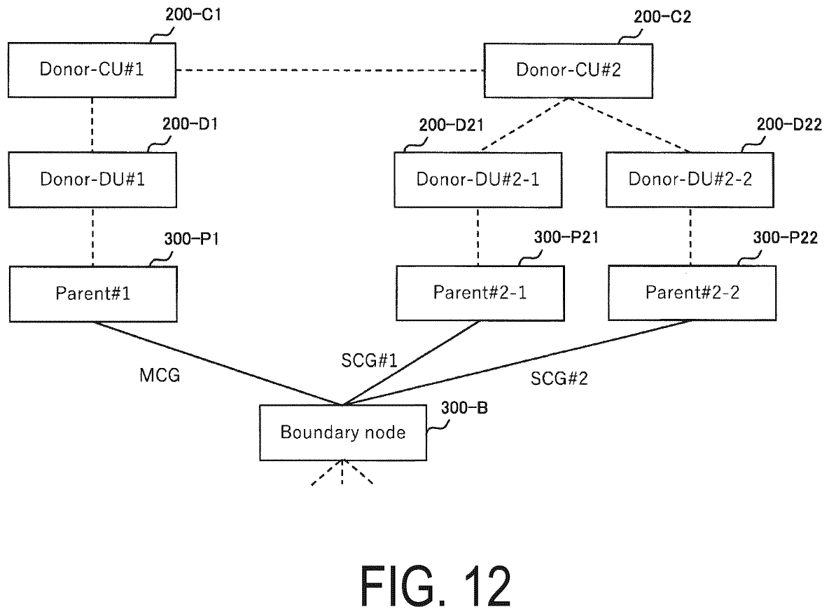

FIG. 12 is a diagram illustrating an example of multi-connectivity according to the second embodiment. In this case as well, when a BH RLF occurs in the BH link for a parent node 300-P1 of the first topology configured with the MCG, the boundary IAB node 300-B selects a parent node 300-P21 of the second topology configured with SCG #1, or selects a parent node 300-P22 of the second topology configured with SCG #2. Regardless of which of the parent node 300-P21 and the parent node 300-P22 the boundary IAB node 300-B selects, the boundary IAB node 300-B performs the header rewriting processing and performs the re-routing processing.

In view of this, in the second embodiment, a priority is configured for a path. Specifically, firstly, the donor node (for example, the CU (200-C1) of the donor node) configures the relay node with a priority configuration in which a priority is configured for each path (for example, the MCG, SCG #1, and SCG #2) of the relay node (for example, the boundary IAB node 300-B). Secondly, the relay node receives a packet. Thirdly, the relay node selects a plurality of entries that match the first routing ID included in the header of the packet from the header rewriting table, and selects the first entry corresponding to the path having the highest priority out of the plurality of entries, based on the priority configuration. Fourthly, the relay node rewrites the first routing ID included in the header to the second routing ID included in the first entry.

Thus, the boundary IAB node 300-B can select one of the parent nodes 300-P in accordance with the priority configuration and perform the header rewriting processing, and can thus appropriately forward the received packet.

### Operation Example According to Second Embodiment

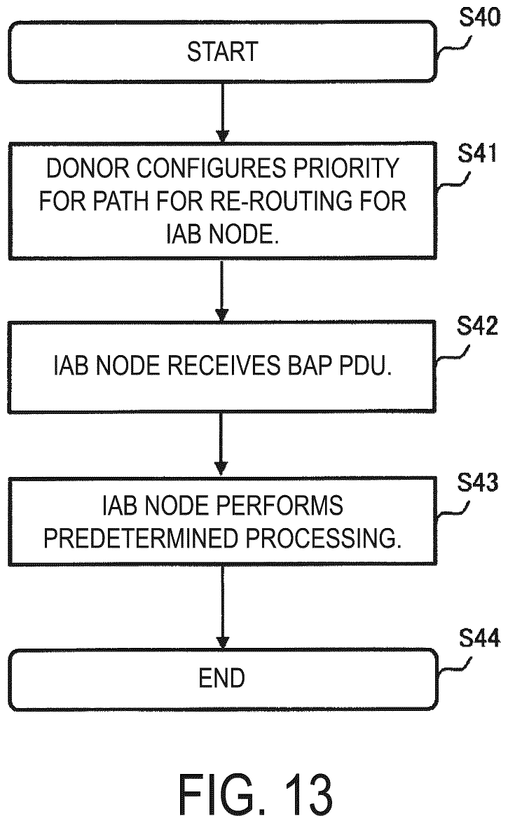

FIG. 13 is a diagram illustrating an operation example according to the second embodiment.

As illustrated in FIG. 13, in Step S40, the donor node 200 starts processing.

In Step S41, the donor node 200 configures a priority for each path for the re-routing for the boundary IAB node 300-B. Specifically, the donor node 200 configures (or transmits) the priority configuration in which the priority is configured for each path of the boundary IAB node 300-B to the boundary IAB node 300-B.

Firstly, types of the paths are as follows. In other words, the path may be a link. In the example of FIG. 11, the priority may be configured for each of the BH link for the parent node 300-P11 configured with the MCG, the BH link for the parent node 300-P12 configured with SCG #1, and the BH link for the parent node 300-P2 configured with SCG #2. The path may be a cell group. In the example of FIG. 11, the priority may be configured for each of the MCG, SCG #1, and SCG #2. The path may be a route indicated by the routing ID. In other words, the priority may be configured for each routing ID. The path may be a destination. In other words, the priority may be configured for each destination. The path may be a topology. In other words, the priority may be configured for each topology. In this case, the priority may be configured for each of an F1 terminating topology (F1-terminating CU's topology) and a non-F1 terminating topology (non-F1-terminating CU's topology). Note that the F1 terminating topology is a topology that terminates the F1-AP in the boundary IAB node 300-B, and in the example of FIG. 11, is a topology on the CU (200-C1) side of the donor node for the packet whose destination is the CU (200-C1) of the donor node. The non-F1 terminating topology is a topology that does not terminate the F1-AP, and in the example of FIG. 11, is a topology on the CU (200-C2) side of the donor node for the packet whose destination is the CU (200-C1) of the donor node. The path may be a route in which the header rewriting processing is executed, or a route in which the header rewriting processing is not executed (non-execution). In other words, the route in which the header rewriting processing is not performed may be, for example, prioritized over the route in which the header rewriting processing is performed (or vice versa).

Secondly, a value of the highest priority may be included in the priority configuration. For example, when MCG=priority “1”, SCG #1=priority “2”, and SCG #2=priority “3” are configured, the priority configuration includes information explicitly indicating that the highest priority is “3”. The highest numerical value may represent the highest priority. The lowest numerical value may represent the highest priority.

Thirdly, the priority configuration may be included in the header rewriting table (Header Rewriting Configuration). For example, regarding the priority configuration, the priority may be included in each entry of the header rewriting table. Regarding the priority configuration, the priority may be associated with each entry of the header rewriting table. The re-routing (that is, local re-routing) in which the header rewriting is unnecessary may be (implicitly) considered to have the highest priority. Alternatively, the re-routing in which the header rewriting is unnecessary may be (implicitly) considered to have the lowest priority. The re-routing in which the header rewriting is unnecessary is not included in the header rewriting table, and thus the path for the re-routing in which the header rewriting is unnecessary is considered to have the highest priority or the lowest priority. The priority for the path whose entry is not included in the header rewriting table may be reported from the donor node 200. The report may be included and reported in an FIAP message, an RRC message, or the like. Including the priority configuration in the header rewriting table allows the transmitter of the BAP layer to perform path selection based on the priority in parallel with the header rewriting processing.

Fourthly, the priority configuration may be included in the routing table (BH Routing Configuration). Regarding the priority configuration, in a manner the same as and/or similar to the case of being included in the header rewriting table, for example, the priority may be included in each entry of the routing table. Regarding the priority configuration, the priority may be associated with each entry of the routing table. Including the priority configuration in the routing table allows the transmitter of the BAP layer to perform path selection based on the priority in parallel with the routing processing.

Referring back to FIG. 13, in Step S42, the boundary IAB node 300-B receives a packet (BAP PDU). For example, the transmitter of the BAP layer (in the IAB-MT) of the boundary IAB node 300-B receives the packet from a receiver of the BAP layer (of the IAB-DU). The transmitter of the BAP layer of the boundary IAB node 300-B may receive the packet from an upper layer (that is, from the UE 100). Then, the boundary IAB node 300-B performs the routing processing on the packet. The following description will be given based on the assumption that the boundary IAB node 300-B fails in the routing processing.

In Step S43, the transmitter of the BAP layer of the boundary IAB node 300-B performs predetermined processing. The predetermined processing is as follows.

Firstly, the transmitter of the BAP layer searches the header rewriting table (Header Rewriting Configuration), and performs processing of making a list of entries for the re-routing that match the routing ID (or the previous routing ID) included in the packet. In other words, the transmitter of the BAP layer selects a plurality of entries that match the routing ID (or the previous routing ID) included in the packet from the header rewriting table, and makes a list of the plurality of entries. The header rewriting table may include entries for the re-routing and entries for the routing, in a manner the same as and/or similar to the first embodiment.

Secondly, the transmitter of the BAP layer selects a path having the highest priority, and selects an entry corresponding to the path out of the list. In other words, the transmitter of the BAP layer selects an entry (for example, the first entry) for the path having the highest priority out of the plurality of entries, based on the priority configuration. Then, the transmitter of the BAP layer rewrites the routing ID (for example, the first routing ID) included in the header of the packet to a new routing ID (for example, the second routing ID) included in the entry. Subsequently, the transmitter of the BAP layer attempts to transmit the packet after the header rewriting. Here, the transmitter of the BAP layer assumes that the BH link on the route is unavailable and the transmission of the packet fails (that is, the re-routing fails). In this case, the transmitter of the BAP layer selects a path having a second priority out of the list, and selects an entry corresponding to the path out of the list. Then, the transmitter of the BAP layer rewrites the routing ID included in the packet to a new routing ID included in the entry. Subsequently, the transmitter of the BAP layer attempts to transmit the packet after the header rewriting. Then, when the transmitter of the BAP layer fails in the transmission of the packet, the transmitter selects a path having a third priority out of the list, and repeats the processing described above. The transmitter of the BAP layer selects a path in order from the highest priority, and attempts to transmit the packet in the path, and when the transmitter fails in the transmission of the packet, the transmitter selects a path having the next priority, and attempts to transmit the packet. In the transmitter of the BAP layer, when packet transmission in a path having a first priority succeeds, packet transmission in the path having the first priority is performed, and when packet transmission in a path having a second priority succeeds, packet transmission in the path having the second priority is performed.

In Step S44, the transmitter of the BAP layer ends the series of processing.

### Other Embodiments

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 or the gNB 200 may be integrated, and at least a part of the UE 100 or the gNB 200 may be implemented as a semiconductor integrated circuit (chipset, system on a chip (SoC)).

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### Supplementary Note

Features relating to the embodiments described above are described below as supplements.

(1)

A communication control method used in a cellular communication system, the communication control method including:
receiving, by a relay node, a packet;
when a first routing ID included in a header of the packet to be routed is present in a first entry for routing in a header rewriting table, rewriting, by the relay node, the first routing ID to a second routing ID included in the first entry; and
when the first routing ID included in the header of the packet to be re-routed is present in a second entry for re-routing in the header rewriting table, rewriting, by the relay node, the first routing ID to a third routing ID included in the second entry.
   (2)

The communication control method according to (1) above, further including:
performing, by the relay node, re-routing processing of the packet for which the rewriting to the third routing ID has been performed; and
when the relay node fails in the re-routing processing, considering, by the relay node, that the packet is a packet to be routed.
   (3)

A communication method used in a cellular communication system, the communication control method including:
configuring, by a donor node, for a relay node, a priority configuration in which priorities are configured for respective paths of the relay node;
receiving, by the relay node, a packet;
selecting, by the relay node, a plurality of entries matching a first routing ID included in a header of the packet from a header rewriting table, and selecting a first entry of the plurality of entries corresponding to a path of the respective paths having a highest priority, based on the priority configuration; and
rewriting, by the relay node, the first routing ID included in the header to a second routing ID included in the first entry.
   (4)

The communication control method according to (3), wherein
the header rewriting table includes the priority configuration.

### REFERENCE SIGNS

1: Mobile communication system
10: 5GC
100: UE
110: Wireless communicator
130: Controller
200: Donor node (gNB)
210: Wireless communicator
230: Controller
300: IAB node
310: Wireless communicator
320: Controller
TP #1, TP #2: Topology

1. A communication control method used in a cellular communication system, the communication control method comprising:
comprising, by a relay node, a packet;
when the packet is a packet to be routed, rewriting, by the relay node, a first routing ID comprised in a header of the packet to a second routing ID, based on information used in header rewriting for routing;
performing, by the relay node, routing processing of the packet for which the rewriting to the second routing ID has been performed;
when the packet is a packet to be re-routed, rewriting, by the relay node, the first routing ID comprised in the header of the packet to a third routing ID, based on information used in header rewriting for re-routing; and
performing, by the relay node, re-routing processing of the packet for which the rewriting to the third routing ID has been performed.

2. The communication control method according to claim 1, further comprising
when the relay node fails in the re-routing processing, considering, by the relay node, that the packet is a packet to be routed.

3. A communication control method used in a cellular communication system, the communication control method comprising:
configuring, by a donor node, for a relay node, a priority configuration in which priorities are configured for respective paths of the relay node;
receiving, by the relay node, a packet;
selecting, by the relay node, a plurality of entries matching a first routing ID comprised in a header of the packet from a header rewriting table, and selecting a first entry of the plurality of entries corresponding to a path of the respective paths having a highest priority, based on the priority configuration; and
rewriting, by the relay node, the first routing ID comprised in the header to a second routing ID comprised in the first entry.

4. The communication control method according to claim 3, wherein
the header rewriting table comprises the priority configuration.

5. A relay node comprising:
a transmitter comprising a packet; and
a controller,
wherein the controller is configured to, when the packet is a packet to be routed,
rewrite a first routing ID comprised in a header of the packet to a second routing ID, based on information used in header rewriting for routing, and
perform routing processing of the packet for which the rewriting to the second routing ID has been performed, and
the controller is configured to, when the packet is a packet to be re-routed,
rewrite the first routing ID comprised in the header of the packet to a third routing ID, based on information used in header rewriting for re-routing, and
perform re-routing processing of the packet for which the rewriting to the third routing ID has been performed.
